(19) United States
(12) Patent Application Publication
(10) Pub. No.: US 2019/0128994 A1
(43) Pub. Date: May 2, 2019

(54) SENSOR SYSTEM

(71) Applicant: Richard Kozdras, Morriston (CA)

(72) Inventor: Richard Kozdras, Morriston (CA)

(21) Appl. No.: 16/176,950

(22) Filed: Oct. 31, 2018

Related U.S. Application Data
(60) Provisional application No. 62/579,428, filed on Oct. 31, 2017.
(60) Provisional application No. 62/597,753, filed on Dec. 12, 2017.

(51) Int. Cl. G01S 5/02; G01S 13/87; G01S 13/82; H04W 84/12

(52) U.S. Cl. CPC G01S 5/02; G01S 13/878; H04W 84/12; G01S 13/82; G01S 13/876

(57) ABSTRACT

A sensor system for gathering data from power-constrained transmitters dispersed over an area. Measurement of the signals from such power-constrained transmitters is taken at multiple locations in and/or around the area. At least some of the measurements are carried out by a receiver that moves in use.

### CROSS-REFERENCE TO RELATED APPLICATIONS

This application claims the benefit of U.S. Provisional Patent Application Ser. No. 62/579,428 filed Oct. 31, 2017 and U.S. Provisional Patent Application Ser. No. 62/597,753 filed Dec. 12, 2017.

### FIELD OF THE INVENTION

The invention relates to the field of sensor systems.

### BACKGROUND OF THE INVENTION

Indoor positioning systems are well known.

In such systems, relatively high power transmitters are fixed to objects, receivers are strategically placed throughout the premises to receive signals from the transmitters and triangulation calculations are carried out using measurements made by the receivers, often involving measurements of the time signals take to travel from the transmitters to the receivers or of the strength of the signals.

[It should be understood that both the transmitters and receivers are often transceivers, to allow for the signals sent to be modified to avoid, inter alia, interference and undue power usage.]

Passive RFID readers are also well known and are often used to monitor the movement of objects between known places, by placing relatively high power RFID readers in doorways and like.

### SUMMARY OF THE INVENTION

Forming one aspect of the invention is an improved system for gathering data from power-constrained transmitters dispersed over an area, the system being of the type where measurements of the signals from such transmitters are taken at multiple locations in and/or around the area, the improvement comprising:
at least some of the measurements being carried out by a receiver that moves in use.

According to another aspect of the invention, the system can include:
sensing apparatus for determining the location of the receiver to permit, in use, the location of the transmitters to be determined by measuring, at three or more known locations, time of flight and/or strength of signals generated by the transmitters and carrying out triangulation calculations.

According to another aspect, the receiver can be a transceiver and can transmit the measurements to a gateway.

According to another aspect, the receiver can follow a fixed track in use or can be a wheeled drone or a flying drone.

According to another aspect, the receiver can be mounted on a fixed track and the sensing apparatus can determine the location of the receiver with reference to the track.

According to another aspect, the sensing apparatus can determine the location of the receiver with reference to the track by one or more of:
sensors carried by the receiver that detect features located at known positions on the track; and
sensors mounted at known locations on the track that detect the receiver.

According to another aspect, the features located at known positions on the track can be selected from the group consisting of: physical structures, lights, sounds, magnetic fields and RF signals.

According to another aspect, the sensors mounted at known locations on the track can be selected from the group consisting of: optic sensors, audible sensors, RF sensors and magnets.

According to another aspect, the sensing apparatus can determine the location of the receiver by triangulation calculations using transmitters located at known locations in the warehouse.

According to another aspect, the receiver can be adapted to receive WiFi signals from battery powered transmitters and can also function as a passive RFID reader.

According to another aspect, the receiver can be mounted on a fixed track and can be selected from the group consisting of: pneumatic tube vehicle, slot-car, battery powered wheeled vehicle and monorail vehicle.

### DETAILED DESCRIPTION OF AN EXEMPLARY EMBODIMENT

An exemplary embodiment of the system is an indoor positioning system for determining the location of objects and RFID-tagged objects in an industrial facility.

The system includes: a track; a plurality of slot-car apparatus; a sensing apparatus; and a plurality of mobile transmitters.

The track is a slot-car track that winds through the facility at locations and elevations such that the track does not interfere with the operation of the facility and such that the track gets relatively near all areas where passive RFID goods are stored.

Each slot-car apparatus is adapted to run along the track and includes a passive RFID reader, an RF receiver and a RF transmitter, all drawing power from the track.

The sensing apparatus includes a plurality of fixed transmitters located at known locations in the facility and a gateway, namely, an RF receiver.

The mobile transmitters are portable devices adapted to periodically send RF signals.

In use: (i) each object to be tracked is provided with one of the mobile transmitters; and (ii) each slot-car apparatus: circulates through the warehouse; at least periodically receives RF signals from the fixed-location transmitters and the mobile transmitters; at least periodically activates the RFID functionality and looks for RFID signals; and at least periodically transmits to the gateway details of the signals received.

Persons of ordinary skill in the art will understand that such a system allows for:
the location of each slot-car apparatus to be tracked in near-real-time [the slot-car apparatus can measure the time of flight or strength of signal from the fixed location transmitters and a triangulation calculation can be made to determine the location of the apparatus therefrom]
the location of the mobile transmitters to be tracked in near-real-time [each slot-car apparatus can measure the time of flight or strength of signal from the mobile location transmitters and a triangulation calculation can be made to determine the location of the mobile transmitters based upon the locations of the slot-car apparatus]
the location of the RFID-tagged goods/objects/persons to be tracked in near-real-time since the location of the slot-car apparatus is known in near-real-time and the location of the RFID-tagged good is closely related to the location of the slot car given the limited range of the reader, which has significant benefits from the standpoint of FACTORY INFORMATION SYSTEMS for automated stock ordering, material handling, etc.
low range wireless sensors to be deployed widely throughout the facility to monitor utilities (hydro ,natural gas, water, power factor), equipment (processing equipment, HVAC systems, lighting , motorized vehicles electrical panels and breakers, conveyor systems, motors/pumps, production lines, alarms)

Whereas a single embodiment is herein described, it will be evident that variations are possible.

For example, whereas a slot-car technology is described, it will be evident that this is not necessary. Automated guided vehicles of any type could be used. For example, wheeled vehicles powered by batteries, fuel cells or combustion engines might be used. A fleet of flying drones could also be used; a portion of the fleet could be in the air at all times, flying autonomously throughout the facility. When a drone needed a charge, it would return to a base station for charging and another would take its place in the line-up. The receivers could also be embodied as a pneumatic cylinder and travel at high speed through a pneumatic tube. Suitable baffles and valves would of course be required, but this embodiment could be useful from the standpoint of avoiding electrical interference associated with self-propulsion.

As well, whereas in the described embodiment, the location of the movable receiver is determined with reference to fixed transmitters, this is not necessary: the location of the receiver could, for example
be determined with reference to the track [i.e. the receiver could carry sensors that detect features located at known positions on the track or sensors could be mounted at known locations on the track that detect the receiver. The features located at known positions on the track could, for example, be physical structures, lights, sounds, magnetic fields, RF signals or others. The sensors mounted at known locations on the track could, for example, be optic sensors, audible sensors, mechanical sensors, RF sensors, magnets or others; or
be determined by receivers mounted at known locations within the facility, and by measurements thereof of transmissions sent by the movable receiver.

Further, whereas the specification makes references to transmitters and receivers, persons of ordinary skill will readily recognize that in many case, each of the various components listed will normally best be embodied as a transceiver for various conventional reasons including phasing signals to avoid interference and synchronizing signals to enable listening/transmitting functions to be intermittent and short duration, to maximize battery life.

Further, whereas Wifi and RFID are specifically mentioned, the system should be understood to have utility with all wireless communication technologies, current and yet-to-be-developed, including but not limited to Zigbee, Bluetooth, BLe, Wi Max, cellular technologies, etc.

Whereas in the exemplary embodiment, the system allows for tracking of mobile transmitters through the use of triangulation calculations, this feature is not strictly necessary; location determination may not be required in all applications, and when required, may in some instances be done merely by reference to the location of the receiver, particularly in the context of relatively low-power transmitters such as passive-RFID.

Further, it will be understood that, if the triangulation methodology is to be utilized, in order to track objects that move at relatively high speed relative to the moving receiver, it may be necessary to have three or more receivers in operation at any given time, receiving signals simultaneously.

As well, whereas an industrial facility is mentioned, it should be understood that the system could be installed to encompass outdoor structures and areas.

Accordingly, the invention should be understood to be limited only by the accompanying claims, purposively construed.

1. An improved system for gathering data from power-constrained transmitters dispersed over an area, the system being of the type where measurements of the signals from such transmitters are taken at multiple locations in and/or around the area, the improvement comprising:
at least some of the measurements being carried out by a receiver that moves in use.

2. The system according to claim 1, further including sensing apparatus for determining the location of the receiver, thereby to permit, in use, the location of the transmitters to be determined by measuring, at three or more known locations, time of flight and/or strength of signals generated by the transmitters and carrying out triangulation calculations.

3. The system according to claim 1, wherein the receiver is a transceiver and transmits the measurements to a gateway.

4. The system according to claim 1, wherein the receiver follows a fixed track in use or is a wheeled drone or is a flying drone.

5. The system according to claim 1, wherein the receiver is mounted on a fixed track and the sensing apparatus determines the location of the receiver with reference to the track.

6. The system according to claim 5, wherein the sensing apparatus determines the location of the receiver with reference to the track by one or more of:
sensors carried by the receiver that detect features located at known positions on the track; and
sensors mounted at known locations on the track that detect the receiver.

7. The system according to claim 6 wherein the features located at known positions on the track are selected from the group consisting of: physical structures, lights, sounds, magnetic fields and RF signals.

8. The system according to claim 6, wherein the sensors mounted at known locations on the track are selected from the group consisting of: optic sensors, audible sensors, mechanical, RF sensors and magnets.

9. The system according to claim 2, wherein the sensing apparatus determines the location of the receiver by triangulation calculations using transmitters located at known locations.

10. The system according to claim 1, wherein the receiver is adapted to receive WiFi signals from battery powered transmitters and is also functional as a passive RFID reader.

11. The system according to claim 1, wherein the receiver follows a fixed track in use and is selected from the group consisting of:
pneumatic tube vehicle
slot-car
internally powered wheeled vehicle
monorail vehicle
induction powered vehicle
magnetically powered vehicle.

12. The system according to claim 2, wherein the receiver is a transceiver and transmits the measurements to a gateway.

13. The system according to claim 2, wherein the receiver follows a fixed track in use or is a wheeled drone or is a flying drone.

14. The system according to claim 2, wherein the receiver is mounted on a fixed track and the sensing apparatus determines the location of the receiver with reference to the track.

15. The system according to claim 2, wherein the receiver is adapted to receive WiFi signals from battery powered transmitters and is also functional as a passive RFID reader.
